(19) United States
(12) Patent Application Publication
(10) Pub. No.: US 2007/0132355 A1
(43) Pub. Date: Jun. 14, 2007

(54) Low profile, low loss closed-loop electrodeless fluorescent lamp

(76) Inventors: Fred L. Palmer, Danvers, MA (US); Jakob Maya, Danvers, MA (US)

Correspondence Address: GREGORY A. STOBBS, 5445 CORPORATE DRIVE, SUITE 400, TROY, MI, 48098, US

(21) Appl. No.: 11/299,333

(22) Filed: Dec. 9, 2005

(51) Int. Cl. H01J 17/26

(52) U.S. Cl. 313/231.01

(57) ABSTRACT

An electrodeless fluorescent lamp is provided with an improved profile. The lamp generally includes: a glass envelope filled with an inert gas and a metal vapor; a coating of phosphor disposed on an inner surface of envelope; and a means for exciting the gas within the glass envelope. To achieve a slimmer profile, the tubes defining the glass envelope have an oval cross-sectional shape.

### FIELD

The present disclosure relates to closed-loop electrodeless fluorescent lamps.

### BACKGROUND

Electrodeless fluorescent lamps are very useful light sources because they are efficient and exceptionally long lived. Such lamps also have excellent color characteristics and can be quickly started without difficulty or damage to the lamp. Closed-loop electrodeless lamps are particularly suited for low profile applications, where there is insufficient room for larger bulb type lamps. Therefore, it is desirable to provide an efficient fluorescent lamp with a slimmer profile for such applications. The statements in this section merely provide background information related to the present disclosure and may not constitute prior art.

### SUMMARY

An electrodeless fluorescent lamp is provided with an improved profile. The lamp generally includes: a glass envelope filled with an inert gas and a metal vapor; a coating of phosphor disposed on an inner surface of envelope; and a means for exciting the gas within the glass envelope. To achieve a slimmer profile, the tubes defining the glass envelope have an oval cross-sectional shape.

In another aspect of this disclosure, the means for exciting the gas is further defined as an induction coil aided by magnetic material which only partially encircles the glass envelope.

Further areas of applicability will become apparent from the description provided herein. It should be understood that the description and specific examples are intended for purposes of illustration only and are not intended to limit the scope of the present disclosure.

### DRAWINGS

FIG. 1 is a top view of an exemplary glass envelope for an electrodeless fluorescent lamp;

FIG. 2 is a cross-sectional view of one of the tubes which forms the glass envelope;

FIG. 3 is a diagram of an exemplary arrangement for squeezing tubes to form an oval cross-sectional shape;

FIG. 4 is a diagram of an exemplary electrodeless fluorescent lamp;

FIGS. 5A-5C depict different types of coupling arrangement for the induction coil of the exemplary electrodeless lamp;

FIG. 6 is a graph illustrating the measured loss of an exemplary electrodeless lamp having two magnetic cores with different gap sizes; and

FIGS. 7A and 7B are diagrams of alternative embodiments for a magnetic core which only partially encircles the glass envelope of the lamp.

### DETAILED DESCRIPTION

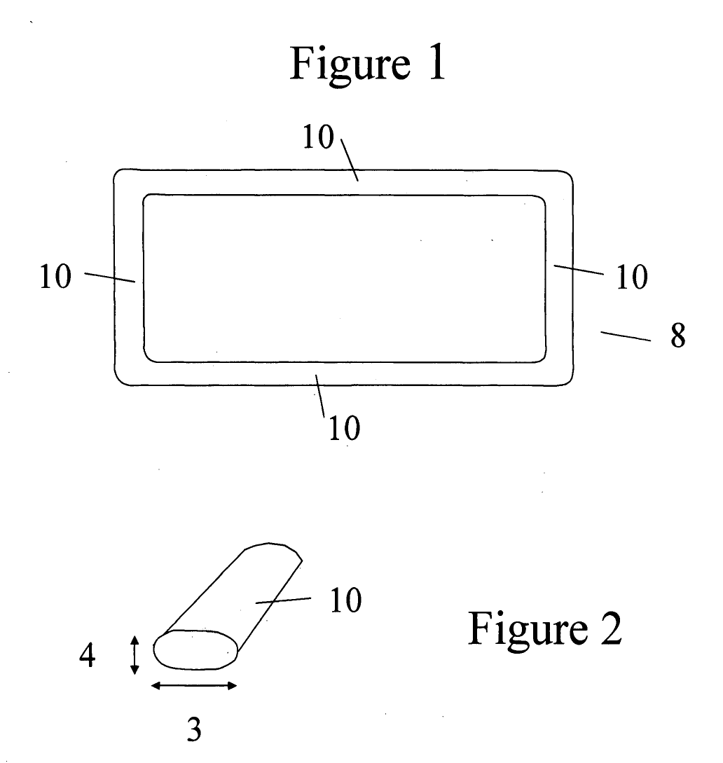

FIG. 1 illustrates an exemplary glass envelope 8 which may serve as the basis for an electrodeless fluorescent lamp. The glass envelope 8 is made from four glass tubes 10 sealed together at each end to form a rectangular closed loop structure. In an exemplary embodiment, the longer tubes are 35 cm long and the shorter tubes are 23 cm long. It is readily understood that other shapes (e.g., a circular shape) and sizes are also contemplated by this disclosure.

The glass envelope 8 is filled with an inert gas, such as argon or krypton, and a metal vapor, such as mercury. The mercury pressure inside the glass envelope may be controlled by the temperature of a cold spot located in an exhaust tabulation (not shown). The glass envelope 8 further includes a coating of phosphor disposed on an inner surface of envelope.

In a preferred embodiment, the cross-sectional shape of the tubes 10 is oval as shown in FIG. 2. Lamps having an oval cross-sectional shape exhibit 20% less coupling loss than lamps having a circular cross-sectional and the same height. In addition, the oval cross-sectional shape provides the same internal plasma volume as a circular shape but with a slimmer profile. For slim profile lamps, the diameter is preferably less than 28 mm and a greater than 19 mm. Tubes having other cross sectional shapes (e.g., rectangular) with an aspect ratio greater than two are also contemplated by the present disclosure. In other words, the width dimension 3 of the cross-sectional shape is larger than the height dimension 4 of the cross-sectional shape.

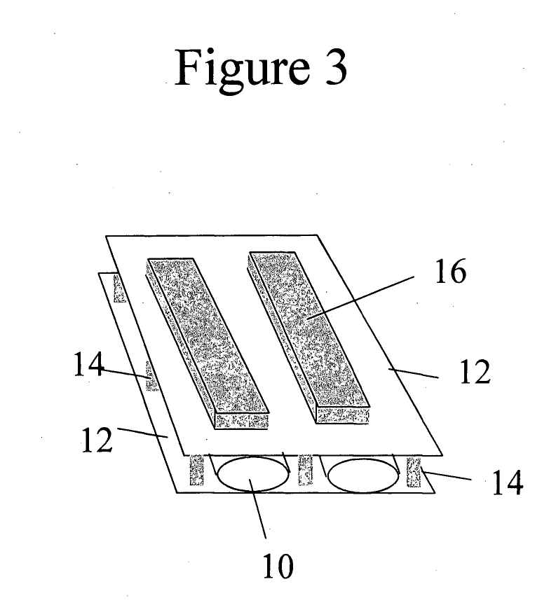

Referring to FIG. 3, tubes 10 having an oval cross-sectional shape can be made from cylindrical tubes by placing the tubes between metal sheets 12 and heating the assembly in an oven. The metal sheets 12 can be made of 3 mm thick stainless steel. Metal stops 14 prevent the tubes from being squeezed by more than the desired amount. Steel weights 16 can be added bringing the total weight up to about 75 grams per centimeter of tube length. A thin layer of Al₂O₃ powder (˜1 micron grain size) helps keeps the tubes from sticking to the metal sheets. The powder may be painted on the sheets as organic slurry similar to the slurry coats that are routinely used to coat the inside walls of fluorescent lamps. Standard borosilicate tube with 25 mm outer diameter and 1.5 mm walls, for example, can be compressed to 19 mm by 28 mm outer diameter in about 30 minutes at 700 degrees Celsius. Better results may be obtained if the steel plates are curved to force an oval shape. The tubes may also be sealed prior to heating with an inert gas pressure of about 280 torr Vs/Vu inside the tubes (Vs and Vu are the respective volumes of the squeezed and unsqueezed tubes). In one approach, squeezed tubes can be joined to form the glass envelope. Alternatively, cylindrical tubes may be used to form U-shaped pieces which are then squeezed to form an oval cross section. Other techniques for forming oval shaped tubes are also contemplated by this disclosure.

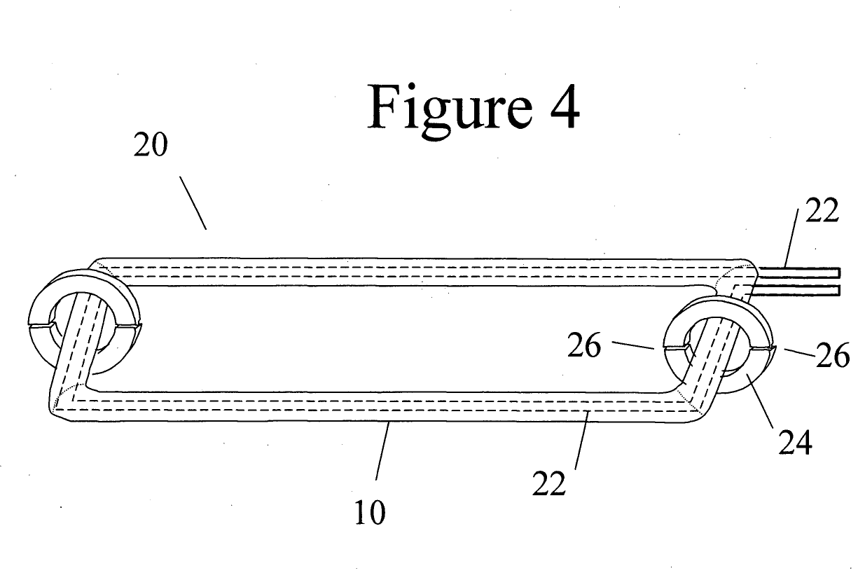

FIG. 4 depicts an exemplary electrodeless fluorescent lamp 20. The lamp 20 is comprised generally of a glass envelope 10, a coating of phosphor disposed on an inner surface of envelope, and a means for exciting the gas within the glass envelope. In this exemplary embodiment, the means for exciting the gas is an induction coil 22 in combination with two magnetic cores 24. An RF power source supplies voltage to the induction coil via a matching circuit (not shown). While the following description is provided with reference to a particular type of excitation means, it is readily understood that the glass envelope described above is suitable for use with other types excitation means, including but not limited to a ferrite free induction coil or a ferrite core transformer.

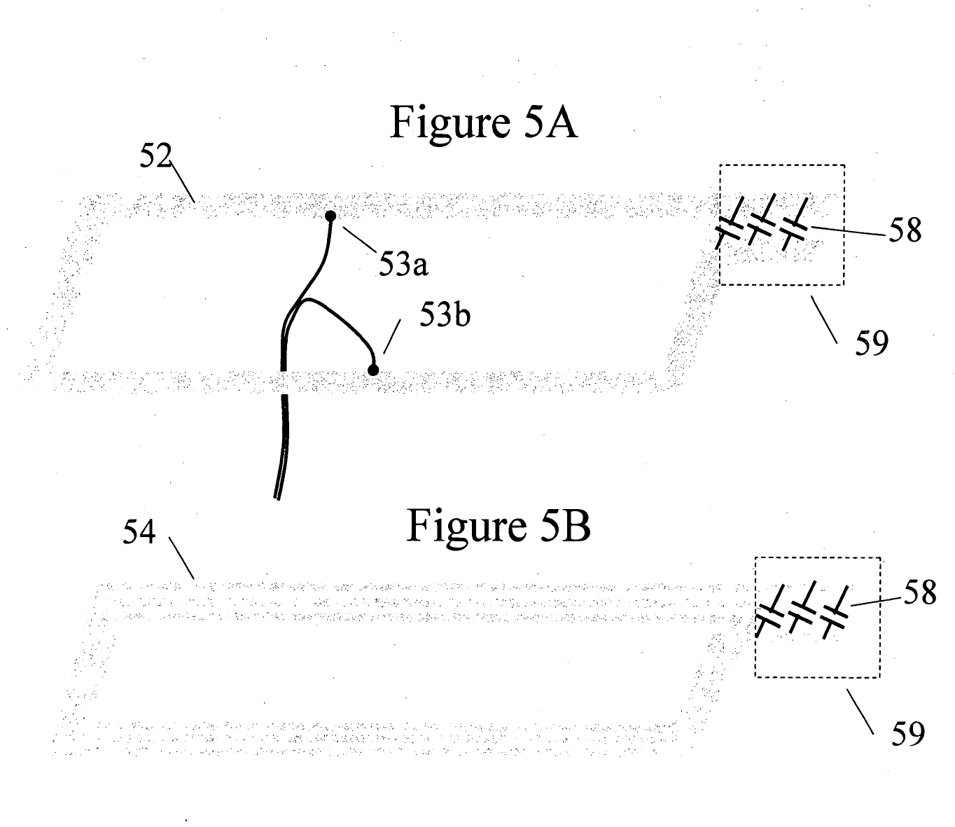

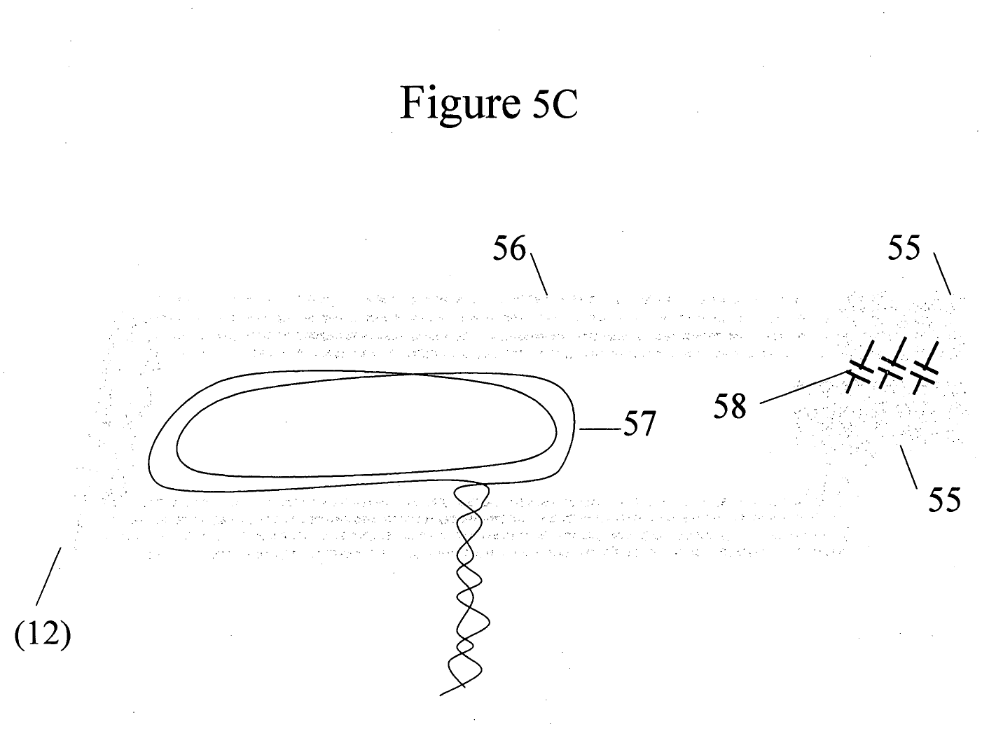

Different types of coupling arrangements for the induction coil are shown in FIGS. 5A-5C. The induction coil is generally disposed along an outer surface of the glass envelope and arranged in parallel with the axis of the tubes forming the glass envelope. In FIG. 5A, the induction coil is a single strip 52 of copper (e.g., 12 mm wide and 0.5 mm thick). Wider couplers are more efficient, but block more of the light emitted from the lamp. For couplers operating at a few hundred kilohertz, a thickness of 0.25 mm is sufficient, but thicker strips are easier to work with. In this arrangement, power is delivered to the strip via two attachment points 53A, 53B as shown.

FIG. 5B shows a coupling arrangement having three loops 54 connected in series. The efficiency of this arrangement is comparable to a single strip coupler having the same total width. However, this coupling arrangement operates at a lower current and a higher voltage which may allow simpler ballast. On the other hand, the higher voltages may reduce lamp life. In this arrangement, the loops may be constructed from either copper strips or Litz wire. Depending on the application, it is also envisioned that more or less loops connected in series may serve as the coupling arrangement.

FIG. 5C shows a coupling arrangement having four Litz wires 56 in parallel. For example, each wire may contain 270 strands of 0.08 mm diameter wire. At a few hundred kilohertz, this coupler has about half the losses of the first coupling arrangement. The preferred configuration has wires that cross in such a way that wires in the center of the group are switched to the outside. The wires 56 are joined at the ends by soldering to copper tabs 55. Additional wires can further reduce losses in this arrangement. In addition, a separate power input loop 57 may be used to deliver power to the arrangement.

In either of these instances, the ends of the coupling arrangement are preferably connected to one or more capacitors 58 to form a resonant circuit 59. For illustration purposes, three capacitors are shown, but ten or more may be needed to handle the current. For frequencies in the hundreds of kilohertz, the total capacitance is on the order of a few hundred nanofarads. The capacitors are preferably made with a low loss dielectric, such as polypropylene or porcelain. It is readily understood that coupling arrangements made from different materials and/or having different configurations are also within the broader aspects of this disclosure.

In another aspect of the present disclosure, the magnetic core does not completely encircle the glass envelope. With reference back to FIG. 4, the ring shape of the magnetic core 24 is interrupted by at least one small gap 26. As shown, a pair of gaps is provided on opposite sides of the core. Although this arrangement is particularly convenient for assembly, other gap locations are also contemplated. When more than one magnetic core is used, it is preferable for the gaps in each magnetic core to have the same effective gap width, where the effective gap width is the sum of gaps along a single ring. A wide variety of magnetic materials, including MnZn ferrite, can be used for the magnetic core.

In operation, the gaps in the core cause less magnetization current to flow inside the core, reducing core losses. The additional current required to run the lamp is carried in the induction coils which are positioned along the tubes of the glass envelope (i.e., following the arc discharge path of the lamp). Unlike conventional approaches, the combination of the gaps in the magnetic coil and the positioning of the induction coils results in improved efficiency for the lamp.

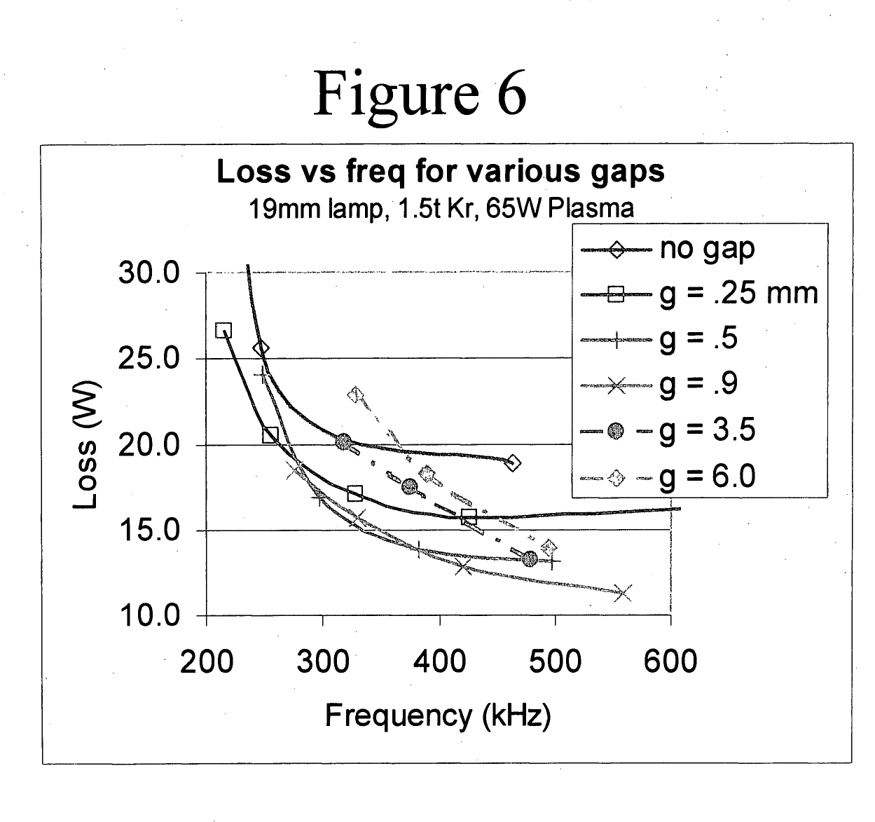

FIG. 6 illustrates the measured total loss of an exemplary electrodeless fluorescent lamp having two magnetic cores with different gap sizes. For illustration purposes, the envelope of the lamp is made of tubes with an oval cross section of 19×28 mm and having a total length of 105 cm. The envelope is filled with mercury vapor and 1.5 torr of krypton. For the most part, the lamp having cores without gaps exhibits more loss than when the cores have a gap. In this exemplary embodiment, the optimum gap width for the magnetic core is between 0.5 mm and 1 mm. However, the optimum gap will vary for other lamp configurations.

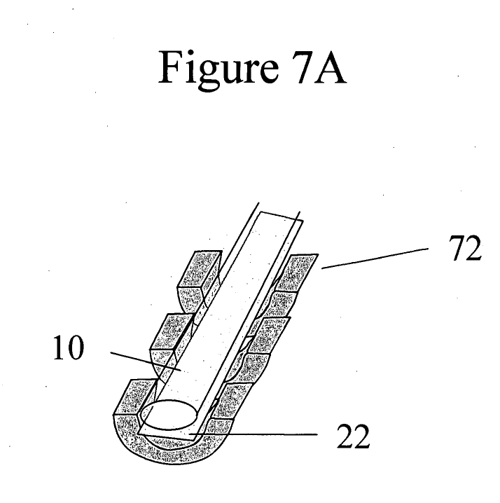

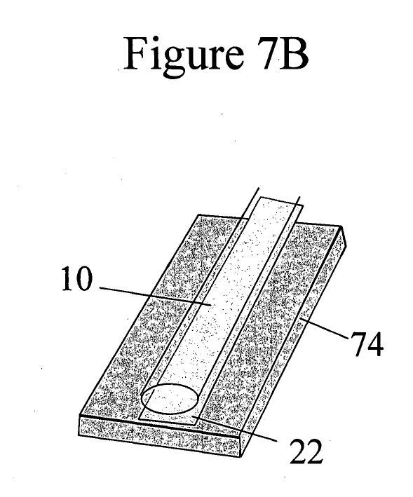

Alternative embodiments for the magnetic core are shown in FIGS. 7A and 7B. In FIG. 7A, the magnetic core is in an arc shaped member 72 which partially encircles the glass envelope 10. In this embodiment, multiple arc-shaped members may be employed to achieve the same performance as a ring shaped core. In FIG. 7B, the magnetic core is flat member 74 disposed on only one side of the glass envelope 10. In each of these embodiments, the induction coil 22 is interposed between the glass envelope 10 and the magnetic core. The flux density tends to be low in these types of cores, so that a wide variety of magnetic materials can be used. In addition, these embodiments are particularly suited for use in backlighting or similar applications where light is directed in a particular direction.

What is claimed is:

1. An electrodeless lamp, comprising:
a glass envelope made of at least one tube formed in a closed loop and filled with an inert gas and a metal vapor, wherein each tube defining a longitudinal axis and having a cross-sectional shape with an aspect ratio greater than two;
a coating of phosphor disposed on an inner surface of envelope; and
a means for exciting the gas within the glass envelope.

2. The electrodeless lamp of claim 1 wherein the tubes forming the glass envelope have an oval cross-sectional shape.

3. The electrodeless lamp of claim 1 wherein the glass envelope is made of four tubes formed in a parallelogram shape.

4. The electrodeless lamp of claim 1 wherein the means for exciting the gas is further defined as a ferrite core transformer.

5. The electrodeless lamp of claim 1 wherein means for exciting the gas is further defined as a conducting coil having a longitudinal axis arranged in parallel with the axis of the tubes forming the glass envelope and disposed along an outer surface of the glass envelope and a power source electrically connected to the conducting coil.

6. The electrodeless lamp of claim 1 wherein the means for exciting the gas is further defined as
a conducting coil having a longitudinal axis arranged in parallel with the axis of the tubes forming the glass envelope and disposed along an outer surface of the glass envelope;
a ring made of magnetic material encircling a portion of the glass envelope and a portion of the coil adjacent thereto; and
a power source electrically connected to the conducting coil.

7. The electrodeless lamp of claim 6 wherein ring includes at least one gap formed therein, thereby shunting current from the ring to the conducting coil.

8. An electrodeless lamp, comprising:
a glass envelope made of at least one tube formed in a closed loop and filled with an inert gas and a metal vapor, wherein each tube defining a longitudinal axis;
a phosphor coating disposed on an inner surface of envelope;
a conducting coil having a longitudinal axis arranged in parallel with the axis of the tubes forming the glass envelope and disposed along an outer surface of the glass envelope; and
a ring made of magnetic material substantially encircling a portion of the glass envelope and a portion of the coil adjacent thereto, wherein the ring includes at least one gap formed therein.

9. The electrodeless lamp of claim 8 wherein the glass envelope is made of four tubes formed in a parallelogram shape.

10. The electrodeless lamp of claim 8 wherein the tubes forming the glass envelope have an oval cross-sectional shape.

11. The electrodeless lamp of claim 8 wherein the tubes forming the glass envelope have a cross-sectional shape with an aspect ratio greater than two.

12. The electrodeless lamp of claim 8 wherein the conducting coil is formed by two or more loops of wire arranged adjacent to each other.

13. The electrodeless lamp of claim 8 wherein the loops of the conducting coil are connected in series or in parallel.

14. The electrodeless lamp of claim 8 wherein the conducting coil is formed using a copper wire or a Litz wire.

15. The electrodeless lamp of claim 8 wherein ends of the conducting coil are electrically connected to a resonant circuit.

16. The electrodeless lamp of claim 8 wherein the gap formed in the ring having a width between 0.5 mm and 1 mm.

17. The electrodeless lamp of claim 8 further comprises a power source operably coupled to the conducting coil.

18. An electrodeless lamp, comprising:
a glass envelope made of at least one tube formed in a closed loop and filled with an inert gas and a metal vapor, wherein each tube defining a longitudinal axis;
a phosphor coating disposed on an inner surface of envelope;
a conducting coil having a longitudinal axis arranged in parallel with the axis of the tubes forming the glass envelope and disposed along an outer surface of the glass envelope; and
an arc shaped core encircling a portion of the glass envelope and a portion of the conducting coil adjacent thereto, wherein the core is made of magnetic material.

19. The electrodeless lamp of claim 18 wherein the glass envelope is made of four tubes formed in a parallelogram shape.

20. The electrodeless lamp of claim 18 wherein the tubes forming the glass envelope have an oval cross-sectional shape.

21. The electrodeless lamp of claim 18 wherein the tubes forming the glass envelope have a cross-sectional shape with an aspect ratio greater than two.

22. The electrodeless lamp of claim 18 wherein the conducting coil is formed by two or more loops of wire arranged adjacent to each other.

23. The electrodeless lamp of claim 18 wherein the loops of the conducting coil are connected in series or in parallel.

24. The electrodeless lamp of claim 18 wherein the conducting coil is formed using a copper wire or a Litz wire.
